(19) United States
(12) Patent Application Publication
(10) Pub. No.: US 2013/0120370 A1
(43) Pub. Date: May 16, 2013

(54) METHOD AND APPARATUS FOR MEASURING ASTHENOPIA OF THREE DIMENSIONAL IMAGE

(71) Applicant: Samsung Electronics Co., Ltd., Suwon-si (KR)

(72) Inventors: Ryutaro OKAMOTO, Yokohama-si (JP); Junta ASANO, Yokohama-si (JP)

(73) Assignee: SAMSUNG ELECTRONICS CO., LTD., Suwon-si (KR)

(21) Appl. No.: 13/676,764

(22) Filed: Nov. 14, 2012

(30) Foreign Application Priority Data
Nov. 14, 2011 (JP) 2011-248725
Jul. 9, 2012 (KR) 10-2012-0074696
Nov. 13, 2012 (KR) 10-2012-0128378

(51) Int. Cl. G06T 15/00

(52) U.S. Cl. CPC G06T 15/00
USPC 345/419

(57) ABSTRACT

A method of measuring asthenopia of displayed 3-dimensional (3D) images, the method including:

changing an alternation frequency for alternating 3D images with different parallaxes and instructing to display 3D images according to the changed alternation frequency;

alternately displaying 3D images with different parallaxes according to the instructed alternation frequency; and

when a subject inputs information indicating whether the subject is able to recognize the 3D images displayed on a display unit, obtaining the corresponding alternation frequency.

### CROSS-REFERENCE TO RELATED PATENT APPLICATION

This application claims the benefit of Japanese Patent Application No. 2011-0248725, filed on Nov. 14, 2011, in the Japanese Patent Office, and Korean Patent Application No. 2012-128378, filed on Nov. 13, 2012, and Korean Patent Application No. 2012-74696, filed on Jul. 9, 2012, in the Korean Patent Office, the disclosure of which is incorporated herein in its entirety by reference.

### BACKGROUND OF THE INVENTION

1. Field of the Invention

The present invention relates to a method and apparatus for measuring asthenopia of three dimensional image by using parallax and alternation frequency as parameters.

2. Description of the Related Art

Recently, electronic devices for displaying 3-dimensional images are increasing. A 3D image is displayed by using parallax between a right-eye image and a left-eye image, where viewing the 3D image may cause asthenopia.

When two lights having different brightness or colors alternately and successively flicker and frequency of the flickering increases, a subject is unable to recognize flickering of the two lights and recognizes the two lights as being constantly turned on or is unable to distinguish the two lights and recognizes mixture of colors of the two light, at a particular frequency. The particular frequency is referred to as a critical fusion frequency (CFF). The CFF is significantly lowered based on fatigue of a subject, and thus the CFF may be used as an index for measuring asthenopia

The most significant reason of asthenopia of a 3D image is parallax between two images. Therefore, if a CFF value including factors other than parallax is used for measuring asthenopia of a 3D image, the asthenopia of the 3D image cannot be measured accurately.

### SUMMARY OF THE INVENTION

According to an aspect of the present invention, there is provided a method of measuring asthenopia of displayed 3-dimensional (3D) images, the method including changing an alternation frequency for alternating 3D images with different parallaxes and instructing to display 3D images according to the changed alternation frequency; alternately displaying 3D images with different parallaxes according to the instructed alternation frequency; and when a subject inputs information indicating whether the subject is able to recognize the 3D images displayed on a display unit, obtaining the corresponding alternation frequency.

The method further includes adjusting 3D images by using a parallax corresponding to the obtained alternation frequency.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing the configuration of an asthenopia measuring apparatus according to an embodiment of the present invention;

FIG. 2 is a diagram showing an example of image data that may be included in an image database according to an embodiment of the present invention;

FIG. 3 is a diagram showing operation of the asthenopia measuring apparatus according to an embodiment of the present invention; and

FIG. 4 is a flowchart showing a method of measuring asthenopia according to an embodiment of the present invention.

### DETAILED DESCRIPTION OF THE INVENTION

The present invention will now be described more fully with reference to the accompanying drawings, in which exemplary embodiments of the invention are shown. In the description of the present invention, if it is determined that a detailed description of commonly-used technologies or structures related to the invention may unnecessarily obscure the subject matter of the invention, the detailed description will be omitted. Like numbers refer to like elements throughout.

Preferred embodiments of the present invention are described hereafter in detail with reference to the accompanying drawings. Before describing the embodiments, the words and terminologies used in the specification and claims should not be construed with common or dictionary meanings, but construed as meanings and conception coinciding the spirit of the invention under a principle that the inventor(s) can appropriately define the conception of the terminologies to explain the invention in the optimum method. Therefore, embodiments described in the specification and the configurations shown in the drawings are not more than the most preferred embodiments of the present invention and do not fully cover the spirit of the present invention. Accordingly, it should be understood that there may be various equivalents and modifications that can replace those when this application is filed.

A 3-dimensional (3D) image is an image displaying an object as if the object exists in a 3D space. Although methods for reproducing actual 3D images are being researched, the most popular method of displaying 3D images is to show images for the left eye and the right eye to the left eye and the right eye of a viewer, respectively, such that the viewer recognizes the images as a single stereoscopic image. To show images for the left eye and the right eye to the left eye and the right eye of a viewer, a polarization goggle, a color filter goggle, or a color filter screen is used. Here, parallax refers to a difference between an image viewed via the left eye and an image viewed via the right eye. A human is able to receive stereoscopic impression because of the parallax.

FIG. 1 is a block diagram showing the configuration of an asthenopia measuring apparatus 100 according to an embodiment of the present invention.

The asthenopia measuring apparatus 100 is an apparatus capable of displaying 3D images and may include a 3D TV, a 3D portable multimedia player (PMP), a 3D tablet PC, a 3D smartphone, and a 3D projector.

Referring to FIG. 1, the asthenopia measuring apparatus 100 may include a display unit 110, an image database 120, an alternation frequency instructing unit 130, an image display control unit 140, an input unit 150, and a diagnosis unit 160.

The display unit 110 is capable of display 3D images.

The image database 120 may store image data for displaying 3D images with different parallaxes.

The alternation frequency instructing unit 130 may change an alternation frequency for switching display of 3D images with different parallaxes and instruct the image display control unit 140 to alternately display 3D images according to the changed alternation frequency.

The image display control unit 140 obtains image data of 3D images with difference parallaxes from the image database 120 and alternately display the obtained image data on the display unit 110 according to the alternation frequency instructed by the alternation frequency instructing unit 130.

The input unit 150 is an interface unit for receiving inputs of a subject, e.g., buttons, keys, etc. The input unit 150 may receive an input from a subject, indicating that the subject is unable to recognize 3D images displayed on the display unit 110.

The diagnosis unit 160 may receive an alternation frequency corresponding to a case in which the input unit 150 receives an input from the subject from the alternation frequency instructing unit 130.

The display unit 110 and the input unit 150 may be a display unit and a user input interface of an electronic device including the asthenopia measuring apparatus 100, respectively. Furthermore, the image database 120 may be stored in a memory of the electronic device including the asthenopia measuring apparatus 100.

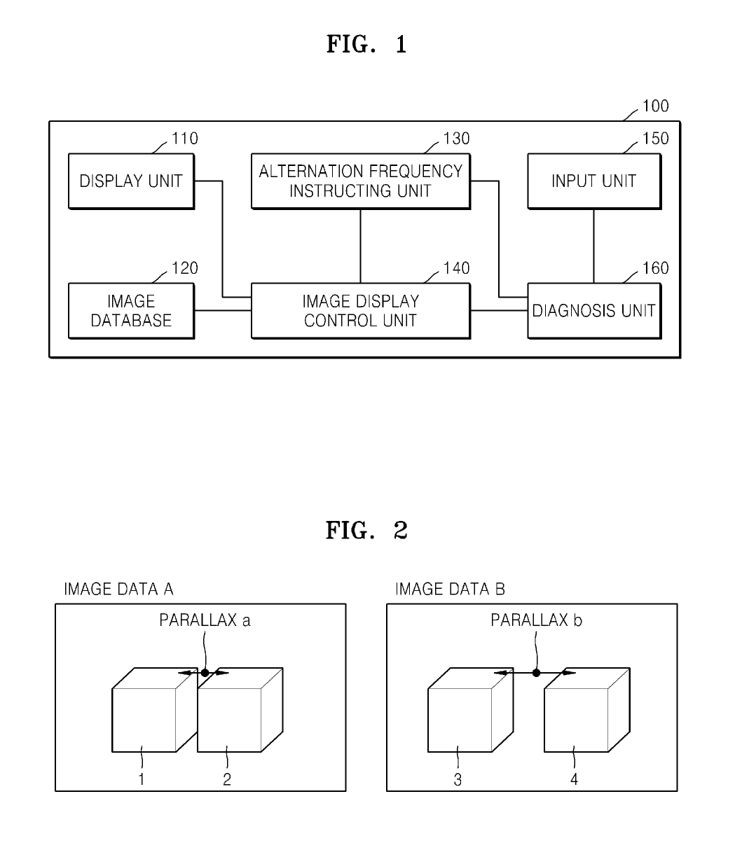

FIG. 2 is a diagram showing an example of image data that may be included in the image database 120 according to an embodiment of the present invention.

As shown in FIG. 2, the image database 120 may include image data A including a 3D image of a parallax a and image data B including a 3D image of a parallax b.

For example, the image data A is 3D image data for displaying a cube, whereas the image data B is 3D image data for displaying a cube, which is identical to the cube of the image data A, at a point in front of the cube displayed by the image data A.

A cube 2 of the image data A is displayed to be recognized by the left eye and a cube 1 of the image data A is displayed to be recognized by the right eye, such that a subject may receive stereoscopic impression. In the same regard, a cube 4 of the image data B is displayed to be recognized by the left eye and a cube 3 of the image data B is displayed to be recognized by the right eye, such that the subject may receive stereoscopic impression.

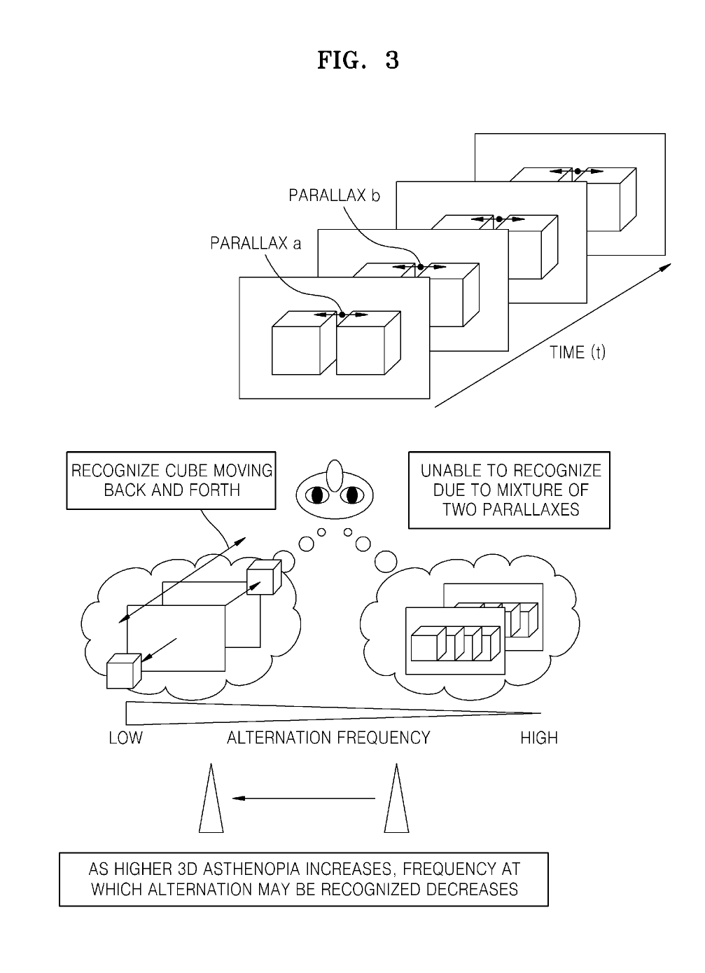

FIG. 3 is a diagram showing operation of the asthenopia measuring apparatus 100 according to an embodiment of the present invention.

Referring to FIG. 3, the asthenopia measuring apparatus 100 may alternately display 3D images of parallax a and 3D images of parallax b. Here, alternation frequency refers to a number of times that 3D images with difference parallaxes are alternately displayed per second.

If alternation frequency is low, a subject may recognize that a cube moves back and forth. However, if alternation frequency increases, parallaxes are mixed, and thus the subject is unable to recognize the cube moving back and forth. The alternation frequency at which a subject is able to recognize alternation of 3D images may decrease as 3D asthenopia of the subject increases. Therefore, the asthenopia measuring apparatus 100 may determine an alternation frequency at which a subject begins to be unable to recognize alternation of 3D images by gradually increasing alternation frequency of the 3D images and use the particular alternation frequency as an index for indicating 3D asthenopia of the subject.

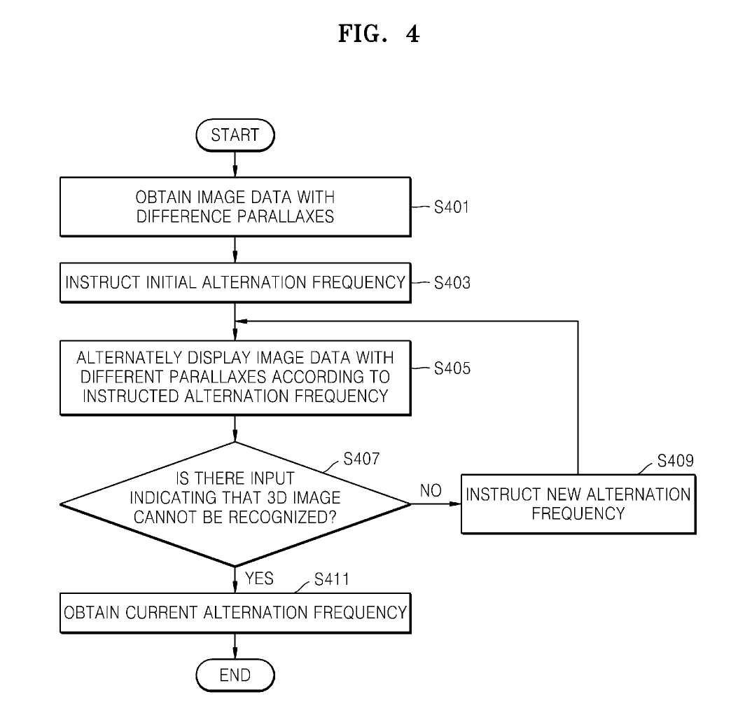

FIG. 4 is a flowchart showing a method of measuring asthenopia according to an embodiment of the present invention.

Referring to FIG. 4, the image display control unit 140 may obtain 3D image data having difference parallaxes, that is, image data A and image data B from the image database 120 (operation S401). The alternation frequency instructing unit 130 determines the initial alternation frequency and may instruct the image display control unit 140 to display 3D images according to the initial alternation frequency (operation S403). The image display control unit 140 may display 3D images of the image data A and 3D images of the image data B alternately on the display unit 110 according to the alternation frequency instructed by the alternation frequency instructing unit 130 (operation S405).

Next, after image data is displayed on the display unit 110 in the operation S405, if the input unit 150 receives an input indicating that a subject is unable to recognize 3D images from the subject before a predetermined period of time is elapsed or a predetermined period of time is elapsed (operation S407), the diagnosis unit 160 obtains a corresponding alternation frequency from the alternation frequency instructing unit 130 or the image display control unit 140 (operation S411), so that the asthenopia measuring apparatus 100 may use the obtained alternation frequency as an index for indicating 3D asthenopia of the subject.

The asthenopia measuring apparatus 100 may show 3D asthenopia based on the alternation frequency obtained by the diagnosis unit 160. For example, the diagnosis unit 160 may transmit image data for displaying obtained alternation frequency or image data for displaying information regarding 3D asthenopia according to preset alternation frequencies to the image display control unit 140. The image display control unit 140 may control the display unit 110 to display the image data received from the diagnosis unit 160. A subject may be informed his or her 3D asthenopia via the displayed image data.

Furthermore, the asthenopia measuring apparatus 100 may adjust parameters for displaying 3D contents, e.g., parallax, based on the alternation frequency obtained by the diagnosis unit 160. For example, the diagnosis unit 160 may remember a relationship between alternation frequencies and parallaxes in advance. Based on the relationship, the diagnosis unit 160 may determine a greater parallax if an alternation frequency decreases, and vice versa. The diagnosis unit 160 may transmit the determined parallax to the image display control unit 140. The image display control unit 140 may control the display unit 110 to externally receive 3D image content data of the particular parallax from a memory (not shown) or from outside and display the received 3D image content data.

Alternatively, the image display control unit 140 may generate image data corresponding to the parallax input by the diagnosis unit 160 based on content data received from outside and may control the display unit 110 to display the generated image data.

Furthermore, the asthenopia measuring apparatus 100 may adjust image displaying parameters other than parallax, e.g., brightness, contrast, hue, sharpness, etc. In this case, the diagnosis unit 160 may remember relationships between alternation frequencies and image displaying parameters in advance, determine image displaying parameters according to an alternation frequency based on the relationships, and transmit the determined image displaying parameters to the image display control unit 140. The image display control unit 140 may control the display unit 110 to display 3D image content data according to the image displaying parameters received from the diagnosis unit 160.

Furthermore, although the asthenopia measuring apparatus 100 gradually increases alternation frequency of 3D images as described above, the asthenopia measuring apparatus 100 may also gradually reduces alternation frequency of 3D images and uses a frequency at which a subject is able to recognize alternation of 3D images (or a frequency just before the frequency at which the subject recognizes the alternation of 3D images) as an index for indicating 3D asthenopia of the subject.

Furthermore, although the image display control unit 140 controls the display unit 110 to alternately display two image data with different parallaxes in the embodiment described above, the image display control unit 140 may also control the display unit 110 to alternately display three or more 3D image data with different parallaxes according to an alternation frequency instructed by the alternation frequency instructing unit 130.

Furthermore, one from among alternately displayed 3D image data with different parallaxes may be image data for displaying images with zero parallax, that is, 2D images.

According to an embodiment of the present invention, since ‘recognition,’ which is the most easily affected by biological conditions, is measured based on parallax, which is the most significant factor of 3D asthenopia. Therefore, 3D asthenopia may be accurately measured. In the convention CFF method, 2 images with different brightness are alternately displayed and the highest alternation frequency at which a subject is able to of two brightness is used as an index for asthenopia.

However, since 3D asthenopia is mainly affected by parallax, 3D asthenopia may be measured more accurately by using images with different parallaxes as in an embodiment of the present invention than by using images with different brightness as in the CFF method. In other words, asthenopia is measured based on recognition of brightness in the CFF method. However, asthenopia may be measured based on stereoscopic recognition of parallaxes according to an embodiment of the present invention, and thus parallax, which is the main factor of 3D asthenopia, may be indirectly quantified. Therefore, when 3D content is displayed, 3D images may be more precisely adjusted for a subject by adjusting 3D parameters, such as parallax, based on an alternation frequency, which is an index of 3D asthenopia according to the present embodiment, than in the CFF method.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of measuring asthenopia of displayed 3-dimensional (3D) images, the method comprising:
changing an alternation frequency for alternating 3D images with different parallaxes and instructing to display 3D images according to the changed alternation frequency;
alternately displaying 3D images with different parallaxes according to the instructed alternation frequency; and
when a subject inputs information indicating whether the subject is able to recognize the 3D images displayed on a display unit, obtaining the corresponding alternation frequency.

2. The method of claim 1, further comprising adjusting 3D images by using a parallax corresponding to the obtained alternation frequency.

3. A 3-dimensional (3D) display apparatus comprising:
a display unit, which displays 3D images;
an alternation frequency instructing unit, which changes an alternation frequency for alternately displaying 3D images with difference parallaxes and controls the display unit to display 3D images according to the changed alternation frequency;
an image display control unit, which controls the display unit to alternately display 3D images with different parallaxes according to the alternation frequency;
an input unit, which receives an input indicating whether a subject is able to recognize the 3D images displayed on the display unit from the subject; and
a diagnosis unit, which receives the corresponding alternation frequency when the input unit receives the input from the subject.

4. The 3D display apparatus of claim 3, wherein the image display control unit adjusts 3D images according to a parallax corresponding to the alternation frequency obtained by the diagnosis unit.

5. A computer readable recording medium having recorded thereon a method of measuring asthenopia of displayed 3-dimensional (3D) images, the method comprising:
changing an alternation frequency for alternating 3D images with different parallaxes and instructing to display 3D images according to the changed alternation frequency;
alternately displaying 3D images with different parallaxes according to the instructed alternation frequency; and
when a subject inputs information indicating whether the subject is able to recognize the 3D images displayed on a display unit, obtaining the corresponding alternation frequency.
